(19) United States
(12) Patent Application Publication
(10) Pub. No.: US 2009/0136700 A1
(43) Pub. Date: May 28, 2009

(54) DECORATING PLATE ASSEMBLY

(76) Inventor: Shih-Kun Weng, Sinjhuang City (TW)

Correspondence Address: Chien-Hui Su, P. O. Box 70-121 Taichung, Taichung City, 40899, TW

(21) Appl. No.: 11/944,471

(22) Filed: Nov. 23, 2007

(51) Int. Cl. B32B 33/00

(52) U.S. Cl. 428/41.8

(57) ABSTRACT

A decorating plate assembly comprising: a decorating plate; the decorating plate assembly having a first layer, a second layer, a third layer and a fourth layer; the first layer being a transparent PLOY layer for scratch-proof, slide-proof and having the effect of protection; the second layer being a transparent PC layer which is located below the first layer for printing; the third layer being a back glue layer and installed at a bottom of the second layer for adhesion; the fourth layer being a separable film and installed below the third layer for isolating the third layer from adhesion to other undesired objects so as to assure the adhesiveness of the back glue layer. The decorating plate assembly can be adhered to an electronic product to have the effects of beauty and protection.

### FIELD OF THE INVENTION

The present invention relates to a decorating plate assembly which is applied to 3C electronic products and has the effect of easy assembly, slide proof; vibration proof and patterns can be printed thereon.

### BACKGROUND OF THE INVENTION

A current trend of electronic devices is portable and compact. The protability has the problem of scratch and destroy due to falling to the ground. Furthermore, these devices require the features of personality so that it is required to change the outlook of the electronic devices so as to have both functions of protection and decoration.

In the prior art Taiwan Patent No. 095202711, “Decorating plate for a Notebook Computer”, a decorating plate has a size slightly larger than that of a casing of a screen and has a buckle. When the plate is placed into the casing, the buckle can be buckled to the casing, the buckle can enclose the casing so that the decorating plate can be fixed to the casing and protect the casing.

However the combination of the buckle and casing is not good. When an impact force is applied, the plate will separate from the casing so as to lose of protection. Furthermore, the prior art structure prints patterns on the surface of the bottom of the casing so that they are easy to be destroyed due to scratch and thus presents an undesired outlook. Thus the decorating effect is lost. Furthermore, in the prior art thermoplastic polyurethane is used, which generates color difference. Moreover, white color cannot be printed and the variation of the color series are finite. Further, TPU is hard and thus it's vibration absorption effect is bad and is easy to destroy due to scratch.

### SUMMARY OF THE INVENTION

The main object of the present invention is to provide a decorating plate assembly, which can improve the defects in the prior art due to buckle effect. Furthermore, the present invention is scratch and vibration proof and has no color shift in printing and colors can be retained thereon for a long time.

To achieve above objects, the present invention provides a decorating plate assembly comprising: a decorating plate; the decorating plate assembly having a first layer, a second layer, a third layer and a fourth layer;

the first layer being a transparent PLOY layer for scratch-proof, slide-proof and having the effect of protection;

the second layer being a transparent PC layer which is located below the first layer for printing;

the third layer being a back glue layer and installed at a bottom of the second layer for adhesion;

the fourth layer being a separable film and installed below the third layer for isolating the third layer from adhesion with other undesired objects so as to assure the adhesiveness of the back glue layer; and

In the present invention, the POLY material is better than the prior art TPU in slide proof and scratch proof. Besides, the POLY may present three dimensional effect so that the decorating plate may present beautiful quality and variation of patterns. Furthermore, the textures or patterns can be printed upon the PC layer (polycarbonate) which is highly flexible and highly transparent, heat-tolerable, impact-tolerable, and stable in the sizes. Thus, it is more precise and bright in printing. Moreover, the decorating plate is replaceable. Other than applied to a notebook computer, when the fourth layer is torn, the decorating plate can be adhered to an upper cover of a notebook computer, so as to have the effects of beauty and protection.

The various objects and advantages of the present invention will be more readily understood from the following detailed description when read in conjunction with the appended drawing.

### BRIEF DESCRIPTION OF THE DRAWINGS

FIG. 1 is an explosive schematic view of the decorating plate assembly of the present invention.

FIG. 2 is a schematic view about the decorating plate assembly of the present invention.

FIG. 3 is a schematic view showing that the decorating plate assembly of the present invention is applied to a notebook computer.

FIG. 4 is a schematic view showing that the decorating plate assembly of the present invention is applied to a decorating plate assembly.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

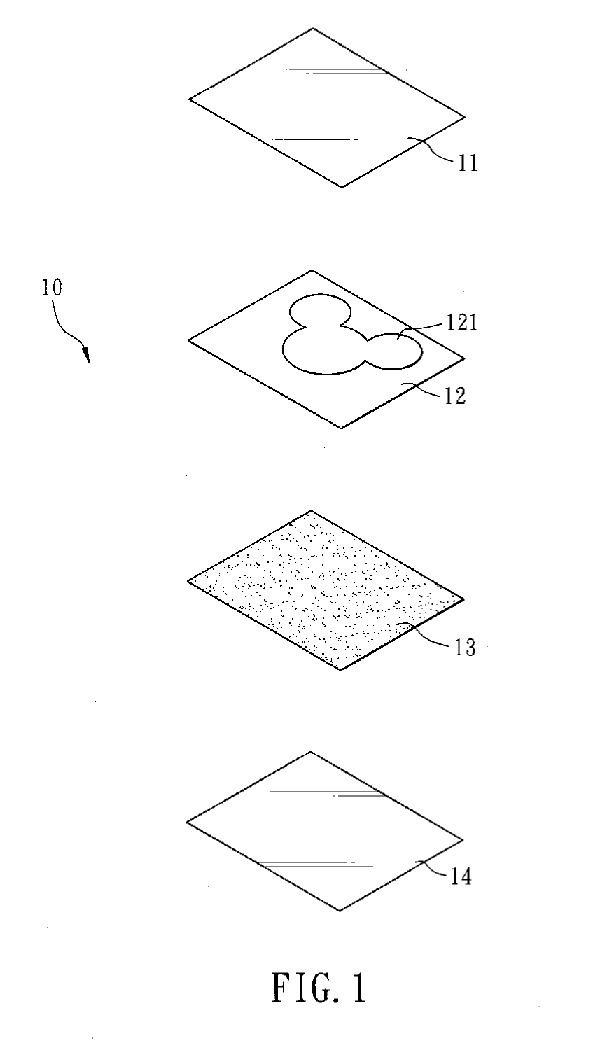

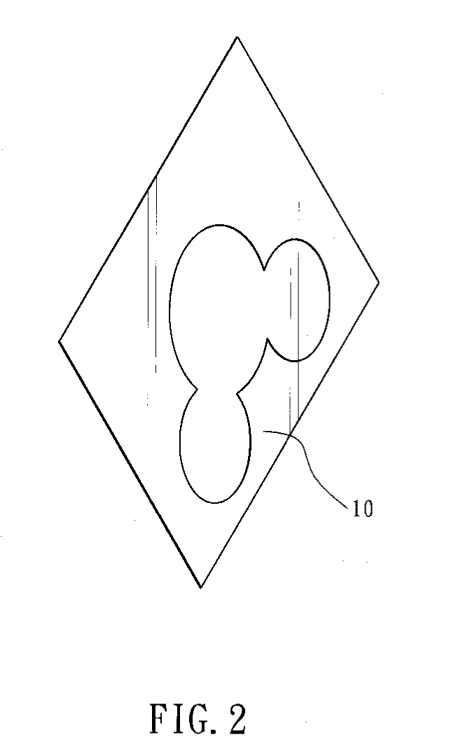

The present invention relates to a decorating plate 10, as shown in FIGS. 1 and 2. The decorating plate 10 has a first layer 11, a second layer 12, a third layer 13 and a fourth layer 14.

The first layer 11 is a transparent PLOY layer for scratch-proof, slide-proof and having the effect of protection. The first layer 11 has a three dimensional structure. For example, an edge of the first layer 11 has a reduced inward shape so that it can be adhered to and aligned to a surface of a product so as to reduce the possibility that the decorating plate 10 is cured upwards.

The second layer 12 is a transparent PC layer which is located below the first layer 11. A bottom surface or a top surface of the second layer 12 is installed with a printed pattern 121. The color of the pattern 121 is not limited. The area of the second layer 12 without the pattern 121 can be printed with any background so as to make the pattern 121 more apparently and colorfully.

The third layer 13 is a back glue layer and is installed at a bottom of the second layer 12 for adhesion.

The fourth layer 14 is a separable film and is installed below the third layer 13 for isolating the third layer 13 from adhesion with other undesired objects so as to assure the adhesiveness of the back glue layer.

In the present invention, the POLY material is better than the prior art TPU in the properties of slide proof and scratch proof. Besides, the POLY may present three dimensional effect so that the decorating plate 10 may present beautiful quality and variation of patterns. Furthermore, the textures or patterns can be printed upon the PC layer (polycarbonate) which is highly flexible and highly transparent, heat-tolerable, impact-tolerable, and stable in the sizes. Thus, it is more precise and bright in printing. Moreover, the decorating plate 10 is replaceable.

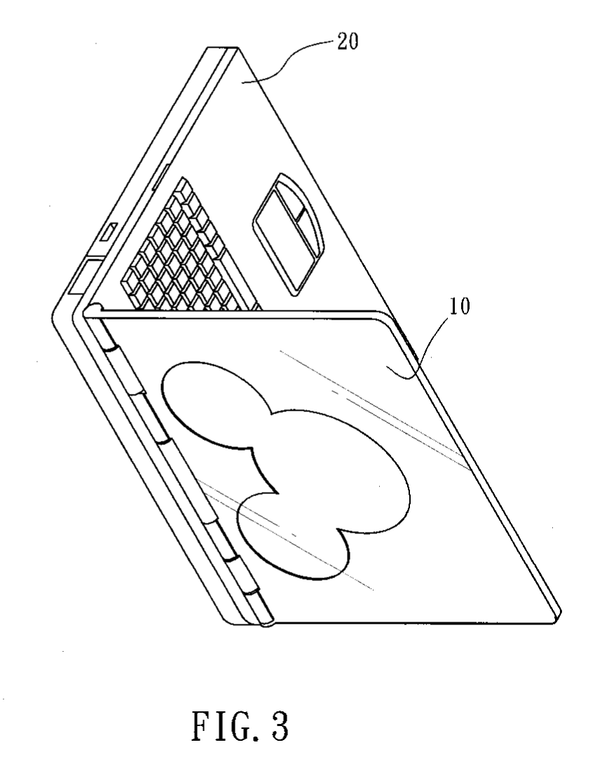

Other than applied to a notebook computer, referring to FIG. 3, when the fourth layer 14 is torn, the decorating plate 10 can be adhered to an upper cover of a notebook computer 20, so as to have the effects of beauty and protection.

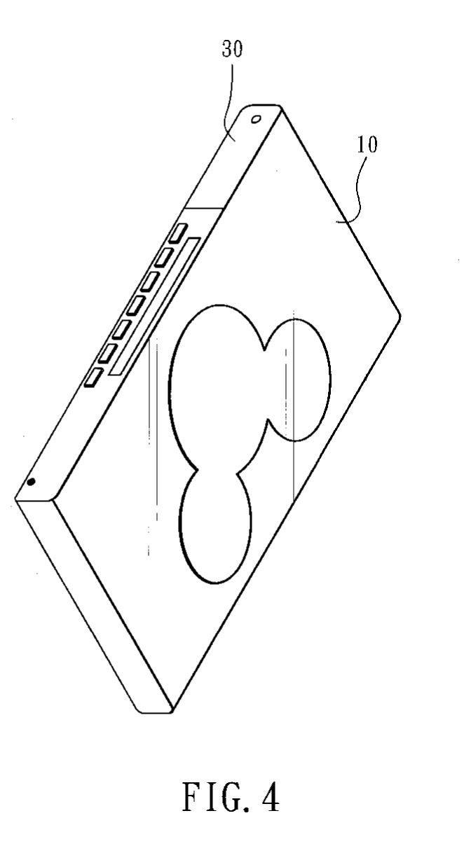

Referring to FIG. 4, the present invention can be applied to a top surface of a DVD video player 30 to present a beautiful outlook.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A decorating plate assembly comprising: a decorating plate; the decorating plate assembly having a first layer, a second layer, a third layer and a fourth layer;
the first layer being a transparent PLOY layer for scratch-proof, slide-proof and having the effect of protection;
the second layer being a transparent PC layer which is located below the first layer for printing;
the third layer being a back glue layer and installed at a bottom of the second layer for adhesion;
the fourth layer being a separable film and installed below the third layer for isolating the third layer from adhesion to other undesired objects so as to assure the adhesiveness of the back glue layer; and
wherein the decorating plate assembly can be adhered to an electronic products to have the effects of beauty and protection.

2. The decorating plate assembly as claimed in claim 1, wherein a top of the second layer serves for printing.

3. The decorating plate assembly as claimed in claim 1, wherein a bottom of the second layer serves for printing.

4. The decorating plate assembly as claimed in claim 1, wherein the first layer has a three dimensional structure.

5. The decorating plate assembly as claimed in claim 1, wherein an edge of the first layer has a reduced inward shape.
